(19) United States
(12) Patent Application Publication
(10) Pub. No.: US 2006/0100849 A1
(43) Pub. Date: May 11, 2006

(54) Pointer initiated instant bilingual annotation on textual information in an electronic document

(76) Inventor: Ning-Ping Chan, El Cerrito, CA (US)

Correspondence Address: Leon E Jew, 24301 Southland Dr, Suite 405, Hayward, CA, 94545, US

(21) Appl. No.: 10/529,087

(22) PCT Filed: Sep. 27, 2003
(86) PCT No.: PCT/US03/30627

§ 371 Date: Sep. 12, 2005

Related U.S. Application Data
(60) Provisional application No. 60/414,623, filed on Sep. 30, 2002.

(51) Int. Cl. G06F 17/20

(52) U.S. Cl. 704/8

(57) ABSTRACT

This invention provides a system and method for providing a user an artificial intelligence based bilingual annotation, displayed in a callout associated with the user's mouse pointer, on a piece of textual information contained in a segment of text adjacent to, or overlaid by, the user's mouse pointer while the user is reading an electronic document on the computer screen.

This application claims priority to the U.S. provisional patent application Ser. No. 60/414,623, filed on 30 Sep. 2002, the contents of which are incorporated by reference herein.

### BACKGROUND OF THE INVENTION

1. Field of the Invention

This invention relates generally to machine translation technology. More particularly, the invention relates to a bilingual linguistic annotation calibration engine (LACE) which comprises a system and method for automatically returning a user from a local computer or a web server an artificial intelligence based bilingual annotation, displayed in a callout or bubble, on a piece of textual information, such as a phrase, a keyword, or a sentence, contained in a segment of text adjacent to or overlaid by the user's mouse pointer while the user is viewing an electronic document on the computer screen.

2. Description of Prior Art

The World Wide Web refers to the complete set of documents residing on all Internet servers that use the HTTP protocol, accessible to users via a simple point-and-click system. Because the Internet is borderless, any user on the earth can access a web site hosted by any web server as long as the devices required for Internet connection are available.

With the broad use of the Internet all over the world, WWW has become the primary information resource for many of those who can access the Internet. Web users seek information not only from the web sites in their own language, but also from the web sites in foreign languages. To assist the users with different language backgrounds, many site-hosts provide multilingual versions of their web sites. For example, in order to attract readers from Western countries, many Chinese, Korean and Japanese web sites include versions in English, German or French. Similarly, to attract Asian readers, some American web sites also include versions in Chinese, Korean or Japanese.

Although, as a matter of fact, a multilingual web site best serves a user who has bilingual need, from the point of view of the site owners, it is not cost effective. First, it is quite expensive to hire professionals to translate the web pages and their updates into different languages. For a large web site with hundreds even thousands of pages of documents, the project of translation is huge. Second, because the translation takes time, the multilingual versions cannot be updated in a timely manner. Third, the more versions a web site has, the more inconsistencies there exist among different versions. Sometimes centrality, integrity, or consistency is of essence. Fourth, a multilingual web site not only burdens the host for requiring larger databases and higher process capabilities, but also burdens the Internet for creating heavier traffic.

Therefore, it becomes a need to provide a user a tool or tools to read a web site which is in a language other than the user's own language.

Ning-Ping Chan et al. have been granted on Aug. 5, 2003 a U.S. Pat. No. 6,604,101 for their invention entitled “METHOD AND SYSTEM FOR TRANSLINGUAL TRANSLATION OF QUERY AND SEARCH AND RETRIAL OF MULTILINGUAL INFORMATION ON A COMPUTER NETWORK”. The patent discloses and teaches a method for translating a query input by the user in the source language (also called the user's language or the subject language) into the target language (also called the object language) and searching and retrieving web documents in the target language and translating the web documents into the source language. According to this invention, the user first inputs a query in a source language through a unit such as the keyboard. This query is then processed by the server at the backend to extract content word from the input query. The next step takes place at the dialectal controller, which is present on the server and performs the function of dialectally standardizing the content word or words so extracted. During this process the user may be prompted for some more so as to refine the search by the user or in case dialectal standardization could not be performed using the initial input query. This is followed by the process of pre-search translation, which comprises of translating the dialectally standardized word into a target language through a translator. This process of translation is followed by inputting the translated word into a search engine in the target language. Such an input yields search results in the target language corresponding to the translated word. The results so obtained are then displayed in the form of site names (URL) which satisfy the search criteria. All the results thus obtained in the target language are then displayed on the user screen. According to the user's needs such results may then be translated back either in whole or in part into the source language. Chan's patent aims at assisting a user to search the web by entering a query in the user's own language, called source language, and returning to the user an entire translation of a targeted web site. In many circumstances, for a user who has some basic knowledge about the target language, the translation of an entire document is not necessary. Instead, an instant bilingual annotation on some key words, phrases or sentences would be good enough.

U.S. Pat. No. 6,236,958, issued to Lange et al. discloses a terminology extraction system which allows for automatic creation of bilingual terminology. The system includes a source text which comprises at least one sequence of source terms, aligned with a target text which also comprises at least one sequence of target terms. A term extractor builds a network from each source and target sequence wherein each node of the network comprises at least one term and such that each combination of source terms is included within one source node and each combination of target terms is included within one target node. The term extractor links each source node with each target node, and through a flow optimization method selects relevant links in the resulting network. Once the term extractor has been run on the entire set of aligned sequences, a term statistics circuit computes an association score for each pair of linked source/target terms, and finally the scored pairs of linked source/target term that are considered relevant bilingual terms are stored in a bilingual terminology database. The whole process can be iterated in order to improve the strength of the bilingual links. Lange's patent does neither teach a linguistic calibrating mechanism using statistic abstraction and fuzzy logic, nor a mechanism of instantly displaying a bilingual annotation in a callout dynamically associated with the user's mouse pointer.

Accordingly, it would be desirable to provide a system and method for automatically providing a computer user an artificial intelligence based bilingual annotation, displayed in a callout associated with the user's mouse pointer, on a piece of textual information contained in a segment of text adjacent to, or overlaid by, the user's mouse pointer while the user is reading an electronic document on the computer screen.

It would be further desirable to provide a system and method for automatically returning a remote online user from a web server an artificial intelligence based bilingual annotation, displayed in a callout associated with the user's mouse pointer, on a piece of textual information contained in a segment of text adjacent to, or overlaid by, the user's mouse pointer while the user is viewing the web site supported by the web server.

It would be further desirable to provide a subscription based system and method for automatically returning a remote online user from a third-party, centralized translation server an artificial intelligence based bilingual annotation, displayed in a callout associated with the user's mouse pointer, on a piece of textual information contained in a segment of text adjacent to, or overlaid by, the user's mouse pointer while the user is viewing the web site supported by any web server.

### SUMMARY OF THE INVENTION

The present invention, defined by the appended claims with the specific embodiments shown in the attached drawings, is directed to a system and method that provides a user a bilingual annotation initiated by the user's mouse pointer. In one preferred embodiment of the invention, it is disclosed a system and method that instantly provides a computer user a bilingual annotation message, contained in a callout associated with the user's mouse pointer, on a piece of textual information while the user, who is reading an electronic document displayed on the computer screen, moves the mouse pointer over, or points the mouse pointer to, a segment of text containing said piece of textual information. This embodiment involves a software application which runs on the user's computer and operates to perform the following steps:

screen-scraping a segment of text in a first language (object language) which is adjacent to, or overlaid by, the user's mouse pointer;

calibrating the screen-scraped segment of text into a query;

translating the query into a second language (subject language); and

displaying the query and its translation (even other reading aid information) in a callout or a virtual bubble closely associated with the user's mouse pointer.

In another preferred embodiment of the invention, it is disclosed a system and method that instantly returns to a web user from a backend server a bilingual annotation message, contained in a callout associated with the user's mouse pointer, on a piece of textual information while the user, who is reading a web page displayed on a computer screen, moves the mouse pointer over, or points the mouse pointer to, a segment of text containing said piece of textual information. This embodiment involves a software application which runs on the backend server of the web site and operates to perform the following steps:

screen-scraping a segment of text adjacent to, or overlaid by, the user's mouse pointer, the segment of text being included in a web page in an object language;

sending the screen-scraped segment of text to the backend server hosting the web page;

calibrating the screen-scraped segment of text into a query;

translating the query into a subject language;

returning the user's computer the data required for displaying the query and its translation (even other reading aid information) in a callout closely associated with the user's mouse pointer; and

displaying the callout according to a signal sent from the server.

Yet in another preferred embodiment of the invention, it is disclosed a method and system that instantly returns a web user from a third-party server a bilingual annotation message, contained in a callout associated with the user's mouse pointer, on a piece of textual information while the user, who is reading a web page or other electronic displayed on a computer screen, moves the mouse pointer over, or points the mouse pointer to, a segment of text containing said piece of textual information. This embodiment involves a software application which runs on a third-party server and operates to perform the following steps:

screen-scraping a segment of text adjacent to, or overlaid by, the user's mouse pointer, the segment of text being included in a web page or other electronic document in an object language;

sending the screen-scraped segment of text to a third-party server which provides bilingual annotation service;

calibrating the screen-scraped segment of text into a query;

translating the query into a subject language;

returning the user's computer the data required for displaying the query and its translation (even other reading aid information) in a callout closely associated with the user's mouse pointer; and

displaying the callout according to a signal sent from the server. The foregoing has outlined rather broadly, the more pertinent and important features of the present invention. The detailed description of the invention that follows is offered so that the present contribution to the art can be more fully appreciated.

### BRIEF DESCRIPTION OF THE DRAWINGS

For a more succinct understanding of the nature and goals of the present invention, reference should be directed to the following detailed description taken in connection with the accompanying drawings in which:

FIG. 1A is a schematic block diagram illustrating a multilingual linguistic annotation calibration engine (LACE) which runs, independently from any web server, on a computing device according to one preferred embodiment of the invention;

FIG. 2B is a flow diagram further illustrating a process for the LACE according to FIG. 1A;

FIG. 2A is a schematic diagram illustrating a system which comprises a multilingual linguistic annotation calibration engine (LACE) which runs on a backend server of a web site according to another preferred embodiment of the invention;

FIG. 2B is a block diagram illustrating the operation steps in both the user's and the backend server's side according to FIG. 2A;

FIG. 2C is a schematic diagram illustrating an exemplary dropdown menu for selecting a subject language to be used in annotation;

FIG. 2D is a schematic diagram illustrating a number of virtual buttons, each of which represents a subject language;

FIG. 2E is a schematic diagram illustrating a rounded rectangular annotation callout;

FIG. 2F is a schematic diagram illustrating a cloud annotation callout;

FIG. 2G is a schematic block diagram further illustrating the preferred embodiment of the invention according to FIG. 2A;

FIG. 3A is a schematic block diagram illustrating a system which comprises an instant multilingual linguistic annotation calibration engine (IM_LACE) which runs on a central translation server which provides IM_LACE service on a subscription basis according to another preferred embodiment of the invention; and

FIG. 3B is a flow diagram illustrating a process for providing centralized instant multilingual LACE service according to the preferred embodiment illustrated in FIG. 3A.

### DETAILED DESCRIPTION OF THE INVENTION

With reference to the drawings, the present invention will now be described in detail with regard for the best mode and the preferred embodiments. In its most general form, the invention comprises a program storage medium readable by a computer, tangibly embodying a program of instructions executable by the computer to perform the steps necessary to provide a user with a bilingual annotation message displayed in a callout associated with the user's mouse pointer.

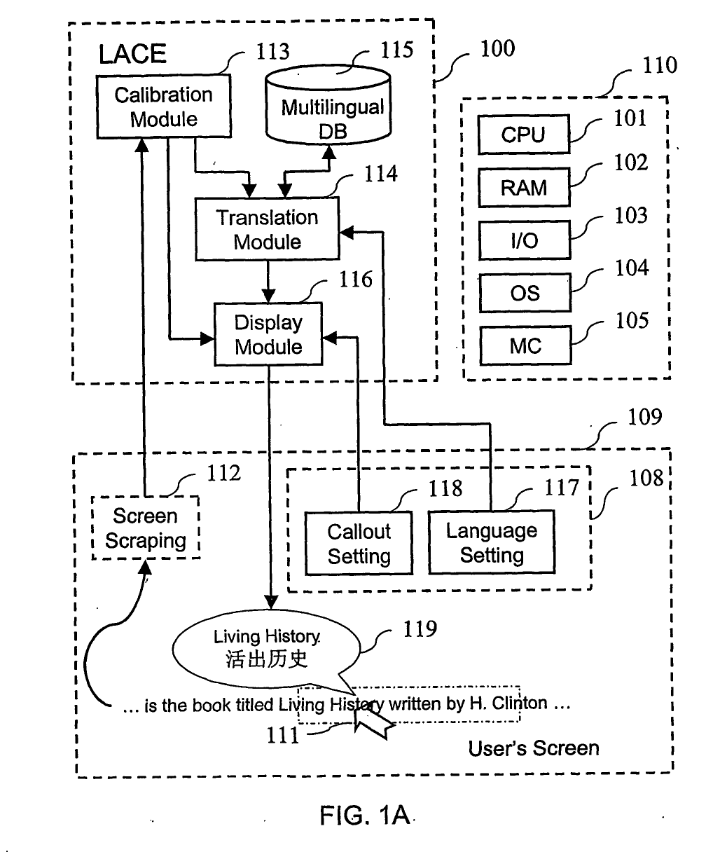

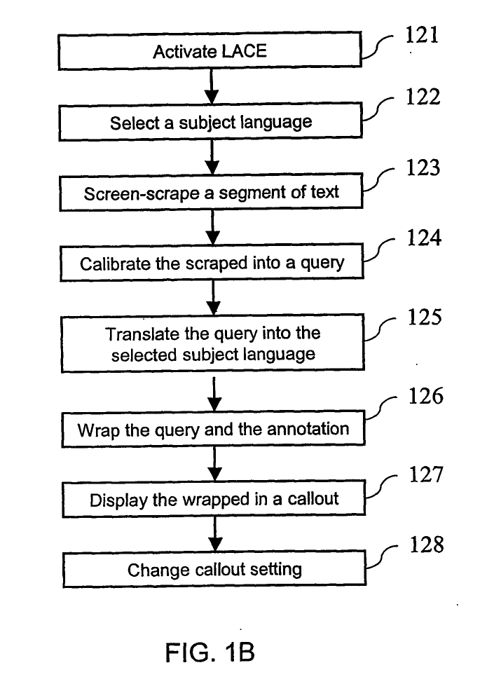

FIG. 1A is a schematic block diagram illustrating a multilingual linguistic annotation calibration engine (LACE) 100 according to one preferred embodiment. Multilingual LACE 100 runs on a computer platform 110 which includes one or more central processing units (CPU) 101, a random memory (RAM) 102, an input/output (I/O) interface 103, an operating system (OS) 104, and optionally a microinstruction code (MC) 105. The multilingual LACE 100 may be part of the microinstruction code (MC) 105 or an application program to be executed via the operating system (OS) 104. Those skilled in the art will readily understand that multilingual LACE 100 may be implemented within other systems without substantial changes.

A user, who is viewing an electronic document in a first language, often referred to as object language, on the computer screen 109, may activate multilingual LACE at any time. The electronic document can be in any format, such as Microsoft Word, Microsoft Excel, Microsoft PowerPoint, PDF, JPEG, etc. When multilingual LACE is activated, the user can set a second language, often referred to as subject language, to be used for annotation from a language setting 117, which can be a graphical user interface (GUI) element comprising a dropdown list or a number of icons, each of which represents an option. In the context of this application, the “subject language” means the language, other than the language used in the target or object document, that the user desires to use for annotating the information contained in the target or object document. Accordingly, the “object language” means the language, other than the subject language, that is used in the document that the user is reading or viewing. In our example as illustrated in FIG. 1A, the user selects simplified Chinese as the subject language. From a callout setting 118, the user may configure the parameters structuring and styling a callout, often referred to as a bubble, to be used to display bilingual annotation. The parameters include, but are not limited to, style, shape, font style and size, and background color. The callout setting 118, similar to the language setting 117, can be a GUI element comprising a dropdown list or a number of icons, each of which represents an option. In one deployment, the language setting 117 and the callout setting 118 are incorporated into a single GUI 108. In another deployment, the language setting 117 and the callout setting 118 are coupled to a displayed callout in such a convenient manner that, for example, these settings are usually hidden but the user may access them by a right-clicking on the callout. Before the user changes these settings, they are in the default status or in the status as the user used the application last time.

A callout or a bubble used in this invention is a dynamically created visual cue overlaid on the computer screen. Although the style, shape, font style and size as well as background color can be preset by the user, the content displayed therein is determined by the display module 116 based on the outputs of the calibration module 113 and the translation module 114. In a bilingual mode, the callout content provided by the display module 116 is bilingual. If the user chooses two languages at the same time from the language setting 117, the display content will be trilingual. It is possible that the user chooses several languages at the same time from the language setting 117 and obtains a multilingual annotation on a query in an object language. Although the callout or the bubble can be fixed in size, preferably it is adaptive according to the content to be displayed. The term “adaptive” herein means elastic, flexible, scalable, automatically adjusted, to fit the content to be displayed. For example, when the query and its translation (and/or even other reading aid information) are very short, the callout or the bubble is relatively small; otherwise, it can be relatively large.

When the user moves her mouse pointer over the electronic document displayed on the computer screen, the mouse pointer initiates a screen-scraping function 112. The mouse pointer, usually referred to as pointer, is a small bitmap e.g. a small arrow provided by the operating system (OS) 104, that moves on the computer screen in response to the movement of a pointing device, typically a mouse. As the mouse pointer moves, it generates motion events and gives the user feedback. It also shows the user which object on the screen will be selected when a mouse button is clicked, sometimes in combination with a drag action. In the preferred embodiments of this invention, the mouse pointer is so configured that when it moves over or points at a line of text, a segment of text is automatically selected. In other words, the user does not need to take click or drag action. Nevertheless, the user can always activate the manual selection at any time.

Now referring back to FIG. 1A, when the user moves the mouse pointer 111 towards a line of text containing “. . . the book titled Living History written by Hillary Rodham Clinton . . . ”, the multilingual LACE application screen-scrapes a segment of text from the line. The length of the screen-scraped segment of text can be configured according to the user's needs. Assuming in our example in FIG. 1A, “Living History written by” is screen-scraped and is sent as an input to the calibration module 113. The calibration module 113 standardizes the input into a calibrated query, such as a phrase, a key word, or a sentence, according to a number of predefined logic, linguistic and grammatical rules. The length of the screen-scraped segment of text can be configured to be adaptive, which means it is elastic, flexible, scalable, automatically adjusted. In that case, the user's preferences and the logic, linguistic and grammatical rules used for calibration are applied to segment length configuration and the screen-scraped text can be directly used as a query for the translation module 114 because the screen-scraped text is already calibrated. In either case, the calibration operation is artificial intelligence (AI) based and thus the calibrated query is very close to a selection made by a human linguistic expert.

The translation module 114 takes the calibrated query as an input and performs an AI-based translation by looking up the multilingual database 115 following a number of predefined logic, linguistic and grammatical rules. Because the database 115 and the translation rules reflect the newest development in the field of machine translation and can be updated from time to time, the translation made by the translation module 114 should be very close to a translation made by a professional translator.

The display module 116 is a multifunctional unit. It accepts the user's callout setting preferences made from the callout setting 118. It also calculates the size of a callout according to the user's preferences and the character string length for the bilingual annotation containing the calibrated query in the object language from the calibration module 113 and the query's translation from the translation module 114. It “wraps” the query and its translation (and/or even other reading aid information) in the callout. It defines the position of the callout according to the mouse pointer's position, the size of the callout and other parameters. Then it sends the data and meta-data to the computer screen which displays the bilingual annotation callout 119 to the user.

FIG. 1B is a block diagram further illustrating a process for the multilingual LACE according to FIG. 1A. The process includes the steps of:

Step 121: Activate LACE (LACE can be automatically activated when the user selects a subject language);

Step 122: Set a subject language to be used for annotating textual information in an object language according to the user's selection or the default selection;

Step 123: Screen-scrape a segment of text which is automatically selected when the mouse pointer moves over or points at a line of text including the segment of text;

Step 124: Calibrate the screen-scraped text into a query for translation;

Step 125: Translate the query into the subject language;

Step 126: Make a callout which fits the query and its translation (and/or even other reading aid information) and wrap them in the callout; and

Step 127: Display the callout in a position determined by various parameters such as the mouse pointer's position, the callout's size, the character string length for the bilingual annotation (i.e. the query, its translation, and/or even other reading aid information), and preferences preset by the user or the default preferences.

Step 128 is performed by the user at any time.

The multilingual LACE described above, with reference to FIG. 1A and FIG. 1B, is preferably deployed as a software program to be distributed to the public. It is also preferably configured to be capable of screen-scraping any electronic document displayed on the user's screen. For example, the user can do multilingual LACE on a WORD document, a PDF document, or an HTML document on the Internet.

The multilingual LACE can also be incorporated in any document creation software such as WORD or EXCEL. In that case, the user can simply activate or deactivate the annotation function from the principal program's general menu.

It is also useful to have a simplified version of the multiple LACE program embedded in a lightweight device such as a PDA, a cellular phone, or a double-way pager.

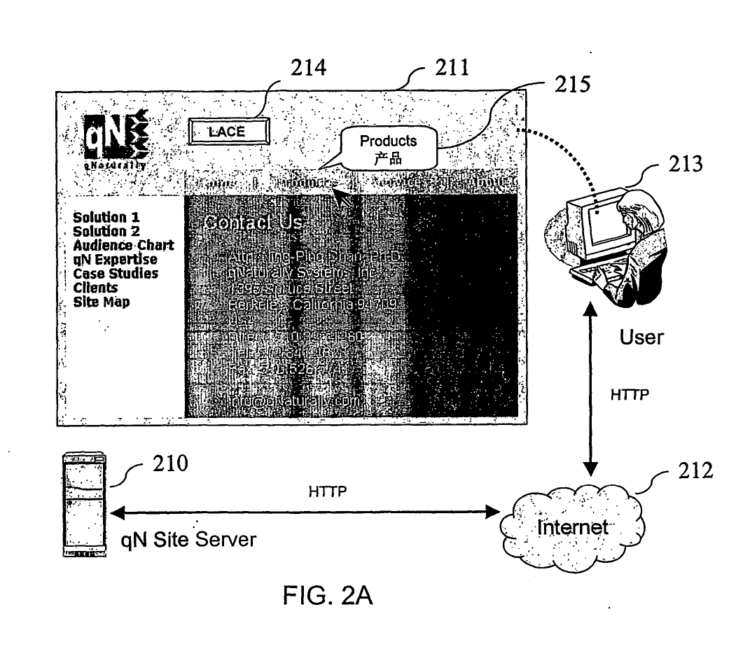

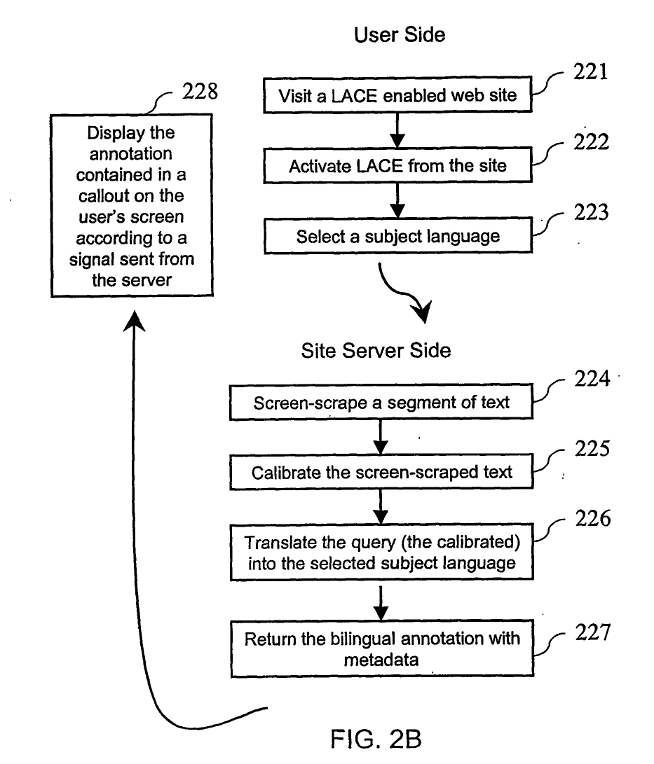

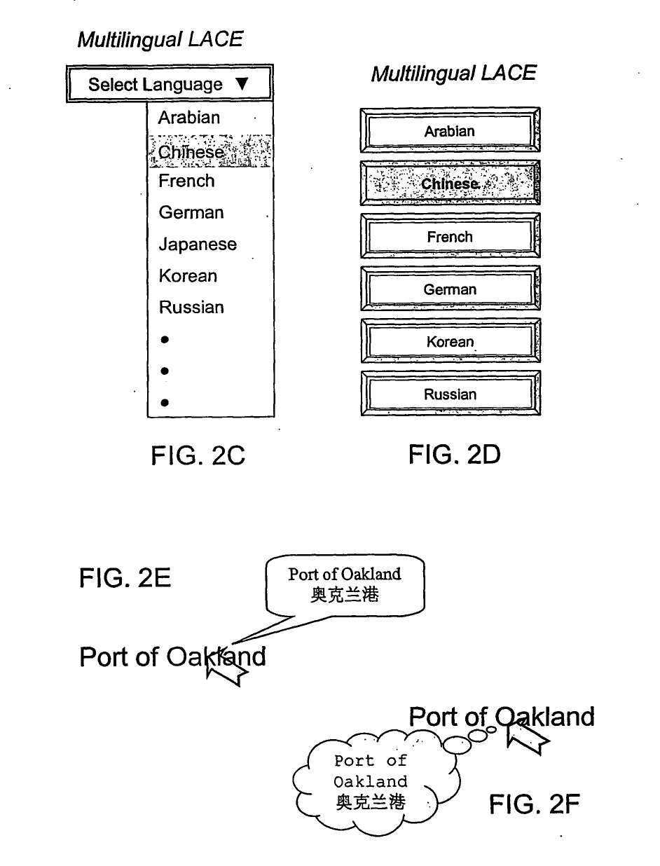

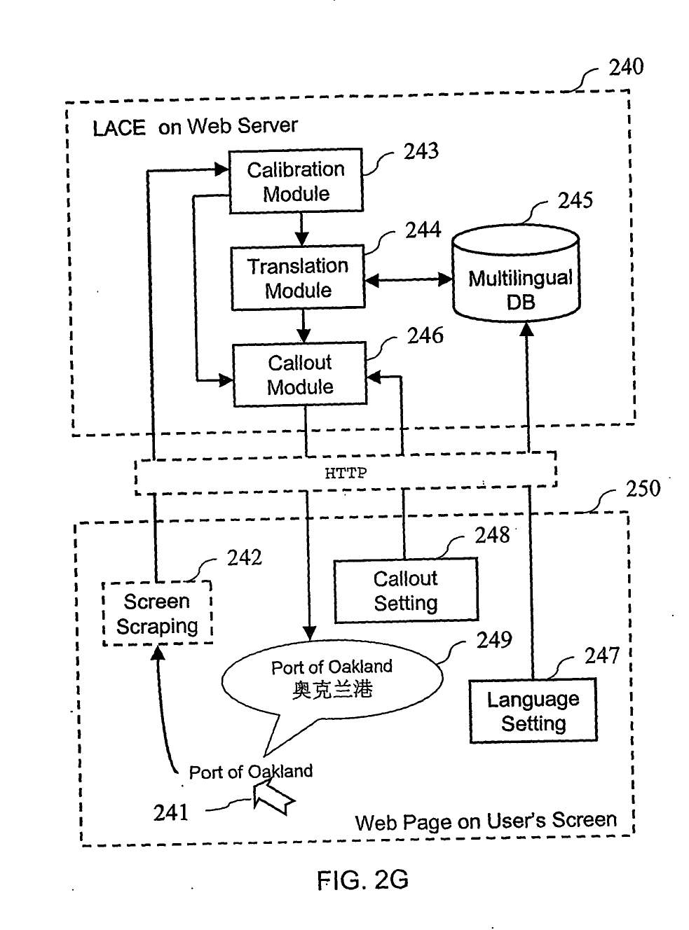

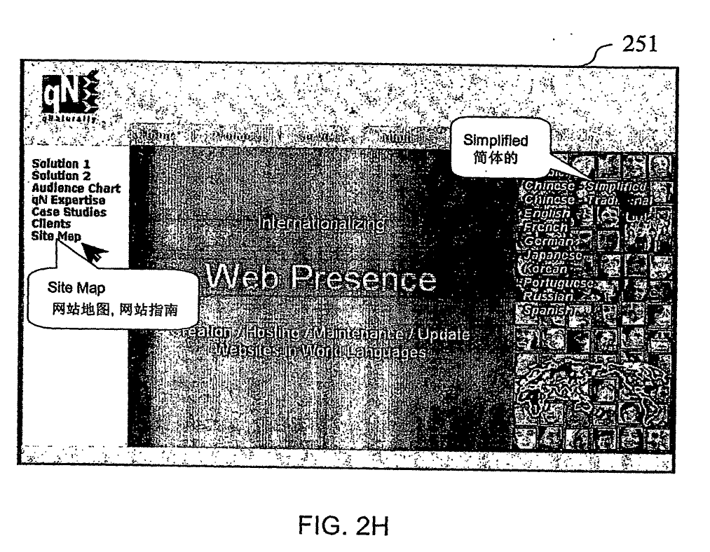

In another preferred embodiment, the invention provides a system and method for dynamically returning a remote online user a bilingual annotation, displayed in a mouse pointer associated callout, on the textual information contained in the website. The system, as schematically illustrated in FIG. 2A includes a web server 210 which supports a website 211 on the Internet 212. The remote end user 213 logs on the Internet 212 by using a browser in her computer and visits a website such as the website 211. The website is in an object language, such as English. The multilingual LACE 214 can be activated from the web site but runs on the web site server 210. Upon activation of the multilingual LACE 214, the user can obtain bilingual annotation on textual information in the website by moving her mouse pointer over, or pointing the pointer at, the text that she wants to understand. For example, when the user moves the pointer over “Products”, a pop-up callout 215 comes to the screen. The callout is associated with the pointer such that a visual reference between the callout and the target text is established. For example, the tail of the annotation callout 215 in FIG. 1 points to the text “Products”.

FIG. 2B is a block diagram illustrating the operation steps in both the user's and the server's side. By entering a URL or by clicking a hyperlink, the user accesses to a website hosted by the web server (Step 221). The website is in an object language, such as English. When the user wants to see bilingual annotation on some words, phrases, or sentences in the website, she needs to activate the multilingual LACE (Step 222) and selects a subject language, such as Chinese, from a list (Step 223). As soon as the subject language is selected, a screen-scraping means is associated with the user's mouse pointer. Following a number of predefined rules represented by an algorithm, the screen-scraper, which is a part of the multilingual LACE application, takes a segment of text which falls in a region spatially close to the pointer and sends the scraped segment of text back to the web server via HTTP (Step 224). Upon standardizing the scraped segment of text into a query (Step 225), the multilingual LACE in the server side translates the query by looking up a powerful multilingual database (Step 226). Then, the web server returns the requested bilingual annotation, including the query and its translation (and/or even other reading aid information), together with the meta-data necessary for defining the callout for the annotation, to the user's computer (Step 227). The user's computer displays the returned data on the screen according to a signal sent from the server (Step 228).

The multilingual LACE according to the embodiment illustrated in FIG. 2A and FIG. 2B is a cross platform application which runs primarily on the backend server. The application includes an activation means which is implemented as a graphical user interface embedded in each page of the website. When the user accesses the website, she can activate or deactivate the multilingual LACE from any page. In one deployment, the user activates or deactivates the application by clicking an activation button. In another deployment, the user activates or deactivates the application by choosing from a dropdown menu. Yet in another deployment, the application is automatically deactivated when the user leaves the web site. These methods for activation and deactivation can be combined in one way or another as long as it is convenient to the user.

The application also includes a selection means for selecting one or more subject languages from a list of options. Similar to the activation means, the selection means can be deployed as a dropdown menu, a number of iconic buttons (each of which representative of a language), or any other elements incorporated in a graphical user interface or a web page.

The activation means and the selection means described above can also be incorporated in one way or another. For example, when the user selects a language from a list of options, the multilingual LACE is automatically activated. To deactivate the application, the user may choose “deactivate LACE” from the list or by clicking an icon.

FIG. 2C is a schematic diagram illustrating an exemplary dropdown menu for selecting one or more subject languages to be used in annotation. FIG. 2D is a schematic diagram illustrating a number of virtual buttons, each of which represents a subject language. As an example, assuming the original site language, i.e. the object language is English and Chinese is selected as the subject language, when the user moves the pointer over or points at a phrase or a sentence in the website, there instantly appears a callout or a “bubble” associated with the pointer. The callout or the “bubble” contains the phrase or sentence in English and its Chinese translation.

The callout or the “bubble” can be configured in any shape, any color, any background, and any size. In addition, the user can set the font style and size used in the callout or “bubble”, just like setting font in most of word processing applications and messaging applications. FIG. 2E illustrates a rounded rectangular annotation callout, in which font “Time New Roman” is used. FIG. 2F illustrates a cloud annotation callout, in which font “Courier New” is used.

The difference between a callout and a “bubble” is that the former has a body and a tail, but the latter has a body only. The tail is useful because it is often used as a reference connector between the annotation callout and the textual information which is annotated. Although a callout is preferably used in various embodiments of this invention, it does not deviate from the essence and scope of this invention if some other kind of visual cue such as square, rectangle, circle, bubble, a “kite” or a “halo” is used to display the returned annotation message.

As an example, the callout can be configured to a fixed size. In this case, only a limited number of characters can be displayed in the callout. When the pointer moves, the callout, like a moving window, only shows the bilingual annotation on the words which are spatially closer to the pointer. The annotation on the words which are getting farther from the pointer automatically disappears from the callout.

As another example, the user can configure a sentence-by-sentence translation scheme. In this case, when the pointer moves over a sentence, the translation of the sentence is displayed in the bubble. Because some sentences are long and some are very short, a flexible bubble is most appropriate.

The multilingual LACE application scrapes text from the screen following a number of predefined rules, for examples: only the text in a line most close to the pointer is scraped; one inch of the segment in the left (or right) of the pointer is scraped; only the segment one inch to the right and one inch to the left of the pointer is scraped; or a whole is scraped, etc.

Now turning to FIG. 2G, which is schematic block diagram further illustrating the preferred embodiment of the invention according to FIG. 1A. When the user points the mouse pointer 241 to the screen text “Port of Oakland”, the screen-scraper 242, which is part of the multilingual LACE application, makes a screen-scraping operation. The screen-scraped segment of text is sent to the server 240 via HTTP, which includes a calibration module 243, a translation module 244 coupled to a multilingual database 245, and a callout making module 246. The calibration module 243 performs a number of logic, linguistic and grammatical operations to calibrate the screen-scraped segment of text into a standardized query. The translation module 244 translates the query, by looking up the powerful multilingual database 245 and performing relevant linguistic and grammatical calculations, into a representation in a subject language selected by the user from the language selection interface 247 which is available in the website 250. Based on the user's preferences and relevant calculations, the callout making module 246 determines the size, style, shape, font style and size of the callout required to display the annotation which includes the query in the object language and the query's translation in one or more subject languages. Preferably, a bilingual representation is needed. The style, font and background color, etc. for the callout 249 can be configured by the user using the callout setting interface 248 which is available in the website 250.

The calibration module 243 may perform functions such as dialectal word lookup, collection of spontaneous innovation, lexical diffusion, statistical abstraction and fuzzy logic, parsing, complex sentences decomposition, etc. The logic, linguistic and grammatical rules used by the calibration module 243 include, but are not limited to the following: Identify a complete sentence by extracting the text between any two neighboring periods (“.”), or between one period (“.”) and an exclamation mark (“!”), or between one period (“.”) and a question mark (“?”), in the screen-scraped text; If no complete sentence is identified, identify a key phrase by ignoring pronouns, copulas, etc.

The callout making module 246 not only determines the size of the callout 249, but also determines the callout's position relative to the mouse pointer 241. As illustrated in FIG. 2H, when the mouse pointer is very close to the right edge of the page, the callout is placed in the pointer's left side so as to keep the callout within the page. Similarly, when the mouse pointer is very close to the left edge of the page, the mouse pointer is placed in the right of the mouse pointer; when the mouse pointer is very close to the upper edge of the page, the callout is placed no higher than the mouse pointer; and when the pointer is very close to the bottom of the page, the callout is placed no lower than the mouse pointer.

Note that the translation module 244 performs translation based on a set of predefined logic, linguistic and grammatical rules which are specific to the language selected. The more sophisticated the rules are, the more precise the translation is. In addition, the translation module 244 is artificial intelligence (AI) based. For example, it is empowered with valence features, collocational probabilities, statistic abstraction as well as fuzzy logic.

The multilingual LACE described above, with reference to FIG. 2A-FIG. 2H, is preferably deployed as a software application specific to the web site hosted by the web site server. It is also preferably configured to be capable of screen-scraping information on the web site only. In other words, the user can not activate the multilingual LACE from one site and use it on other documents other than these posted in the web site. Otherwise, the system would become a free carrier.

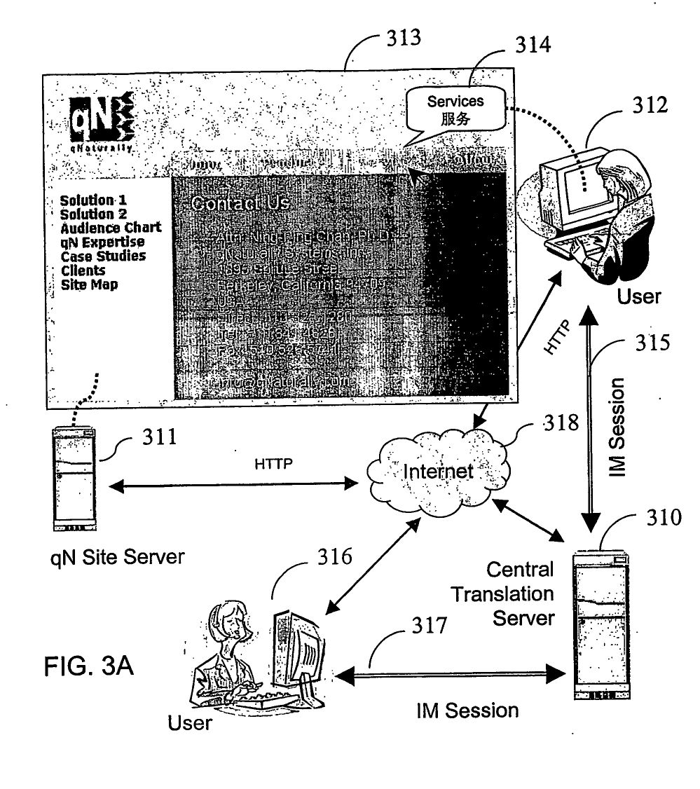

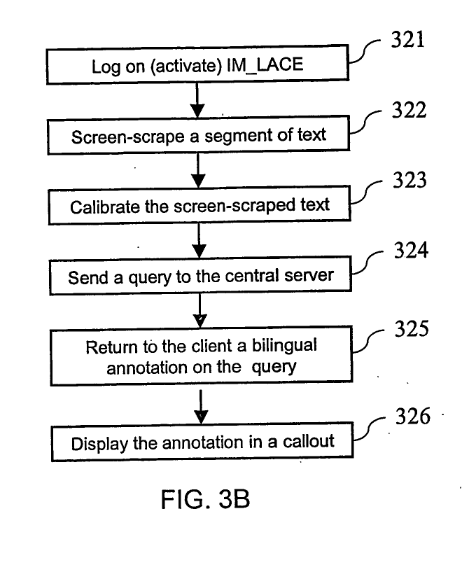

Yet in another preferred embodiment of the invention as illustrated in FIG. 3A, an instant multilingual LACE service, called IM_LACE, is provided from a central translation server 310 using an instant messaging (IM) framework, which is either an independent IM system or incorporated in an existing IM system such as NetMeeting, MSN Messenger, Yahoo! Messenger, AIM, etc. The data exchange between users and the central translation server 310 is supported by web service interfaces, such as SOAP/XML/HTTP, and the related protocols.

Preferably, IM_LACE service is subscription based. An individual user, such as user 312 or user 317 subscribes the service by registration and downloading the IM_LACE client application. When the client application is downloaded, the user can log in the service and use it online against any electronic document. The client application can be configured to execute the calibration and callout making tasks but leaves the translation, which usually requires a large database, for the central server 310. In FIG. 3A, user 316 is using the IM_LACE service in the IM session 317. Similarly, user 312 in IM session 315 is using the IM_LACE service to view a web site supported by the qN site server 311 on the Internet 318.

FIG. 3B is a block diagram illustrating a process according to the embodiment of FIG. 3A. The process includes the steps of:

Step 321: Log on (activate) the IM_LACE system;

Step 322: Screen-scrape a segment of text adjacent to, or overlaid by, the user's mouse pointer, the segment of text being included in a web page or other electronic document in an object language;

Step 323: Calibrate the screen-scraped segment of text into a query;

Step 324: Send the query to the centralized translation server;

Step 325: Return translation to the IM_LACE client application in the user's local computer; and

Step 326: Display the query and its translation (and/or even other reading aid information) in a callout closely associated with the user's mouse pointer.

The advantages of the invention described above are numerous. First, by calibrating the screen-scraped text using an AI-based module such as the calibration module 243 in FIG. 2G, a more content-relevant annotation is made available.

Second, the translation module is also AI-based. By adopting highly sophisticated AI translation technology, the translation is as much as close to human expert translation.

Third, the annotation is dynamic because the displaying callout or bubble is associated with the user's mouse pointer and the displayed bilingual annotation is specifically on the segment of textual information spatially close to the mouse pointer.

Fourth, the system is user-friendly because a user can easily set the style, font and background color etc. of the callout or bubble.

Fifth, as an elegant device by providing instant, pop-up, contextualized translation of key information to foreigners without going into expense creating a site in a whole different language, LACE helps maintain integrity and centrality of the principal site. Foreigners only have to select which subject language they want to activate.

Although the invention is described herein with reference to the preferred embodiment, one skilled in the art will readily appreciate that other applications may be substituted for those set forth herein without departing from the spirit and scope of the present invention.

Accordingly, the invention should only be limited by the Claims included below.

1. A system for providing a user with bilingual annotation on a piece of textual information in a first language contained in an electronic document displayed in the user's screen, the system comprising a processor which is configured to:
screen-scrape a segment of text adjacent to, or overlaid by, the user's pointer;
calibrate said screen-scraped segment of text into a query according to one or more logic, linguistic and/or grammatical rules;
translate said query into a second language by looking up a database and applying a set of logic, linguistic and grammatical rules; and
display a visual cue on the user's screen, said visual cue containing said query, said query's translation and/or other reading aid information.

2. The system of claim 1, wherein said segment of text is fixed in length.

3. The system of claim 1, wherein the length of said segment of text is automatically adjusted according to one or more logic, linguistic and/or grammatical rules.

4. The system of claim 1, wherein said visual cue is dynamically associated with the user's pointer.

5. The system of claim 4, wherein said visual cue comprises a tail which approximately overlaps with the user's pointer.

6. The system of claim 1, wherein said visual cue is fixed in size.

7. The system of claim 1, wherein said visual cue is adaptive to fit the content therein.

8. A computer usable medium containing instructions in computer readable form for carrying out a process for providing a user with bilingual annotation on a piece of textual information in a first language contained in an electronic document displayed in the user's screen, said process comprising the steps of:
screen-scraping a segment of text adjacent to, or overlaid by, the user's pointer,
calibrating said screen-scraped segment of text into a query;
translating said query into a second language; and
displaying a callout on the user's screen, said callout containing said query, said query's translation and/or other reading aid information.

9. The computer usable medium of claim 8, wherein said segment of text is fixed in length.

10. The computer usable medium of claim 8, wherein the length said segment of text is automatically adjusted according to one or more logic, linguistic and/or grammatical rules.

11. The computer usable medium of claim 8, wherein said callout is dynamically associated with the user's pointer.

12. The computer usable medium of claim 11, wherein said callout's tail approximately overlaps with the user's pointer.

13. The computer usable medium of claim 8, wherein said callout is fixed in size.

14. The computer usable medium of claim 8, wherein said callout is adaptive to fit the content therein.

15. A method for providing a user with bilingual annotation on a piece of textual information in a first language contained in an electronic document displayed in the user's screen, comprising the steps of:
screen-scraping a segment of text adjacent to, or overlaid by, the user's pointer;
calibrating said screen-scraped segment of text into a query according to one or more rules;
translating said query into a second language by looking up a database and applying a set of logic, linguistic and grammatical rules; and
displaying an annotation callout on the user's screen, said annotation callout containing said query, said query's translation and/or other reading aid information.

16. The method of claim 15, wherein said segment of text is fixed in length.

17. The method of claim 15, wherein the length said segment of text is automatically adjusted according to one or more logic, linguistic and/or grammatical rules.

18. The method of claim 15, wherein said callout is dynamically associated with the user's pointer.

19. The method of claim 18, wherein said callout's tail approximately overlaps with the user's pointer.

20. The method of claim 15, wherein said callout is fixed in size.

21. The method of claim 15, wherein said callout is adaptive to fit the content therein.

22. A system for returning to a remote user from a web server a bilingual annotation on a piece of textual information in a first language contained in a website supported by the web server, said system comprising an application which operates to:
screen-scrape a segment of text adjacent to, or overlaid by, the user's pointer;
calibrate said screen-scraped segment of text into a query;
translate said query into a second language; and
send a signal to display said query, said query's translation and/or other reading aid information in a visual cue on the user's screen.

23. The system of claim 22, wherein said application comprises a graphical user interface embedded in each page of said web site, said graphical user interface comprising:
means for activation or deactivation of said application; and
means for selecting said second language from a list of languages.

24. The system of claim 23, wherein said application is automatically activated when said second language is selected.

25. The system of claim 22, wherein said segment of text is fixed in length.

26. The system of claim 22, wherein the length of said segment of text is automatically adjusted according to one or more logic, linguistic and/or grammatical rules.

27. The system of claim 22, wherein said visual cue's position is dynamically associated with the user's pointer.

28. The system of claim 27, wherein said visual cue comprises a tail which approximately overlaps with the user's pointer.

29. The system of claim 28, wherein said visual cue is fixed in size.

30. The system of claim 22, wherein said visual cue is adaptive to fit the content therein.

31. The system of claim 23, wherein said graphical user interface further comprises:
means for setting parameters of said visual cue.

32. A method for returning to a remote user from a web server a bilingual annotation on a piece of textual information in a first language contained in a website supported by the web server, comprising the steps of:
screen-scraping a segment of text adjacent to, or overlaid by, the user's pointer;
sending said screen-scraped segment of text to the web server;
calibrating said screen-scraped segment of text into a query according to one or more rules;
translating said query into a second language by looking up a database and applying a set of logic, linguistic and grammatical rules; and
returning said query along with said query's translation to the user's computer; and
sending a signal to display a callout containing said query, said query's translation and/or other reading aid information on the user's screen.

33. The method of claim 32, wherein said application comprises a graphical user interface embedded in each page of said web site, said graphical user interface comprising:
means for activation or deactivation of said application; and
means for selecting said second language from a list of languages.

34. The method of claim 33, wherein said application is automatically activated when said second language is selected.

35. The method of claim 32, wherein said segment of text is fixed in length.

36. The method of claim 32, wherein the length of said segment of text is automatically adjusted according to one or more logic, linguistic and/or grammatical rules.

37. The method of claim 32, wherein said callout's position is dynamically associated with the user's pointer.

38. The method of claim 37, wherein said callout's tail approximately overlaps with the user's pointer.

39. The method of claim 32, wherein said callout is fixed in size.

40. The method of claim 32, wherein said callout is adaptive to fit the content therein.

41. The method of claim 32, wherein said graphical user interface further comprises:
means for setting parameters of said callout.

42. A system for providing real-time multilingual annotation service over a global network from a server to a user, said system comprising:
(a) a client application which runs on the user' computer, said client application being operable to:
screen-scrape a segment of text in a first language, said segment of text being adjacent to, or overlaid by, the user's pointer;
calibrate said screen-scraped segment of text into a query;
send said query to the server; and
display an annotation callout which contains said query and the translation of said query returned from the server; and
(b) a server application which runs on the server, said server application being operable to:
translate said query into a second language by looking up a database and applying a set of logic, linguistic and grammatical rules; and
return the translation of said query to the client application.

43. The system of claim 42, wherein said segment of text is fixed in length.

44. The system of claim 42, wherein said segment of text is automatically adjusted according to one or more logic, linguistic and grammatical rules.

45. The system of claim 42, wherein said callout is dynamically associated with the user's pointer.

46. The system of claim 45, wherein said callout's tail approximately overlaps with the user's pointer.

47. The system of claim 42, wherein said callout is fixed in size.

48. The system of claim 42, wherein said callout is adaptive to fit the content therein.

49. A method for providing real-time multilingual annotation service over a global network from a server to a user, said method comprising:
screen-scraping a segment of text in a first language, said segment of text being adjacent to, or overlaid by, the user's pointer;
calibrating said screen-scraped segment of text into a query;
sending said query to the server;
translating said query at the server into a second language by looking up a database and applying a set of logic, linguistic and grammatical rules;
returning the translation of said query to the user's computer; and
displaying an annotation callout which contains said query, the translation of said query, and/or other reading aid information, returned from the server.

50. The method of claim 49, wherein said segment of text is fixed in length.

51. The method of claim 49, wherein the length of said segment of text is automatically adjusted according to one or more logic, linguistic and/or grammatical rules.

52. The method of claim 49, wherein said callout is dynamically associated with the user's pointer.

53. The method of claim 52, wherein said callout's tail approximately overlaps with the user's pointer.

54. The method of claim 49, wherein said callout is fixed in size.

55. The method of claim 49, wherein said callout is adaptive to fit the content therein.

56. A system for providing an annotation on a piece of textual information in a first language contained in an electronic document stored in a server communicatively connected to a client via a network, the system comprising a processor configured to:
receive from the client data identifying said piece of textual information;
calibrate said identified textual information into a query according to one or more logic, linguistic and/or grammatical rules;
translate said query into a second language by looking up a database and applying a set of logic, linguistic and grammatical rules; and
forward to the client a translation of said query.

57. A computer usable medium containing instructions in computer readable form for carrying out a process for providing a user with bilingual annotation on a piece of textual information in a first language contained in an electronic document displayed in the user's screen, said process comprising:
receiving data identifying said piece of textual information;
calibrating said piece of textual information into a query;
translating said query into a second language; and
forwarding said translated query to the user.

58. A method for providing a user with bilingual annotation on a piece of textual information in a first language contained in an electronic document displayed in the user's screen, said method comprising:
receiving data identifying said piece of textual information;
calibrating said piece of textual information into a query;
translating said query into a second language; and
forwarding said translated query to the user.
